(19) United States
(12) Patent Application Publication
(10) Pub. No.: US 2012/0090394 A1
(43) Pub. Date: Apr. 19, 2012

(54) SYSTEM AND METHOD FOR ACOUSTIC CHARACTERIZATION OF SOLID MATERIALS

(76) Inventors: SOLIMAN ABDALLA, Alexandria (EG); Aly Mohamed Abdel-Daiem, Jeddah (SA); Fahad Al-Marzouki, Jeddah (SA)

(21) Appl. No.: 12/906,018

(22) Filed: Oct. 15, 2010

(51) Int. Cl. G01N 29/04

(52) U.S. Cl. 73/596

(57) ABSTRACT

The system and method for acoustic characterization of solid materials provides for the characterizing a solid sample based on an acoustic intensity spectrum of an attenuated acoustic signal transmitted through the solid sample. In use, a database of known intensity spectra associated with a plurality of solid materials is first formed. An acoustic generator is then positioned against a first surface of the sample to be tested. An acoustic sensor is positioned against a second surface of the sample to be tested, and the acoustic generator generates an acoustic signal having a fixed intensity. An intensity spectrum of an attenuated acoustic signal transmitted through the sample is measured with the acoustic sensor, and the measured intensity spectrum of the attenuated acoustic signal is compared against the database of known intensity spectra to determine at least one material forming the sample.

### BACKGROUND OF THE INVENTION

1. Field of the Invention

The present invention relates to the characterization of solid materials, and particularly to a system and method for acoustic characterization of solid materials that is based on the acoustic intensity spectrum of an attenuated acoustic signal transmitted through the solid sample.

2. Description of the Related Art

Acoustic transmission loss through solid materials has been studied since the early 1900's. Buckingham's early work in the field resulted in a broad estimation of the ratio between transmitted pressure on a surface to incident pressure being logarithmic. In the simplified diagram of FIG. 2, incident pressure wave PW_{I} travels through a first fluid F₁ toward the first surface 118 of a solid wall or slab 112. A portion of the initial acoustic wave is transmitted through the solid wall or slab 112, resulting in a transmitted pressure wave PW_{T}, which travels through a second fluid F₂ away from the second surface 120 of solid wall or slab 112, and a reflected pressure wave PW_{R}, which travels in the opposite direction, through the first fluid F₁. Horizontal distance in FIG. 2 is measured along the X-axis, with X=0 being located centrally (along the horizontal X-axis) with respect to slab 112.

In the simplification of FIG. 2, upon which Buckingham's work was based, calculations may only be performed for normal incidence of incident pressure wave PW_{I} with respect to the vertically oriented first surface 118 (which is also considered to be perfectly planar), although under real world conditions, an acoustic source will produce random or near-random incidence upon a surface.

Beyond simplifications and estimations, the fluid dynamic equations governing pressure waves impinging upon a surface are highly complex and vary with both frequency and position. The equations are further complicated by the effects of multiple degrees of incidence on the surface. Modern numerical methods, such as mode simulation analysis, statistical energy analysis, finite element analysis, boundary element analysis and the like, allow for such complex computations to be easily made with the aid of a computer, thus permitting modeling of acoustic transmission using real world conditions and without simplifications and broad estimations.

Modern analyses of acoustic transmission loss are generally directed toward calculation of sound reduction (in terms of wave intensity, typically measured in dB) imparted by a partition. Such analyses are often made on idealized cases, where the partition is considered to have an infinite surface area and boundary conditions are not considered. Under real world conditions, the transmission of sound from the first fluid to the second fluid in FIG. 2 is very complex. With regard to FIG. 2, we consider the opposed first and second surfaces of slab or partition 112 to have matching finite surface areas S_{W}.

If there is a diffuse sound field in the source room that produces a sound pressure Pₛ and a corresponding intensity of:

$${I}_{S} = \frac{{P}_{s}^{2}}{4 {ρ}_{0} {c}_{0}} , \qquad ( 1 )$$

which is incident on the transmitting surface 118, a fraction τ of the incident power is transmitted into the receiving room through the wall 112, such that the transmitted power is given by:

$${W}_{r} = {I}_{S} {S}_{W} τ = \frac{{P}_{s}^{2} {S}_{W} τ}{4 {ρ}_{0} {c}_{0}} . \qquad ( 2 )$$

In the above, the power transmitted into the receiving room is given by Wᵣ, ρ₀ represents the density of the second fluid, and c₀ represents the speed of sound in the second fluid. If the receiving room is highly reverberant, the sound field there also will be dominated by the diffuse field component. The mean square pressure in the receiving room is given by:

$$\frac{{P}_{r}^{2} {S}_{W} τ}{{ρ}_{0} {c}_{0}} = \frac{{P}_{s}^{2} {S}_{W} τ}{{R}_{r} {ρ}_{0} {c}_{0}} , \qquad ( 3 )$$

where S_{W} is the area of the transmitting surface 118 (measured in m²) and Rᵣ is the room constant in the receiving room (also measured in m²). The above can be expressed as a level by taking the logarithm of each side and defining transmission loss as:

ΔL_{TL}=−10 log τ, (4)

such that the equation for the transmission of sound between two reverberant spaces is given by:

$${\overline{L}}_{r} = {\overline{L}}_{s} - Δ {L}_{TL} 10 log ( \frac{{S}_{W}}{{R}_{r}} ) , \qquad ( 5 )$$

where Lᵣ represents the spatial average sound pressure level in the receiver room (measured in dB), L^{s} represents the spatial average sound pressure level in the source room (measured in dB), and L_{TL} represents the reverberant field transmission loss (also measured in dB). FIG. 3 is a plot illustrating the attenuation of acoustic energy as a function of frequency and as represented by the logarithmic relationship given by equation (5).

The limp mass approximation for the normalized panel impedance holds for thin walls or heavy membranes in the low-frequency limit, where the panel acts as one mass moving along its normal, and bending stiffness is not a significant contributor. Using this impedance, one can easily calculate the transmissivity.

The reason for using this approach is that the elementary theory resulting in equation (5) predicts a transmission loss of zero for grazing incidence, so if the limiting angle is 90°, a non-physically meaningful result is obtained. It has, thus, become standard procedure to select a maximum angle that yields the best fit to the measured data. This turns out to be about 78°, and gives what is known as the field-incidence transmission loss.

Recently, the proposition of “hyperbolic conduction” (also referred to as the “second sound wave”) for solid materials with non-homogeneous inner structures has run into a serious controversy. While one group of investigators has observed very strong evidence of hyperbolic conduction in such materials, and experimentally determined the corresponding relaxation times to be on the order of tens of seconds, another group has found that their experiments do not show any such relaxation behavior, and the conventional Fourier law of conduction is good enough to describe conduction. It would be desirable to find a consistent conduction mechanism that not only resolves this controversy, but provides a method for accurately characterizing solid materials using the transmission of sound waves therethrough.

Thus, a system and method for acoustic characterization of solid materials solving the aforementioned problems is desired.

### SUMMARY OF THE INVENTION

The system and method for acoustic characterization of solid materials provides for the characterization of the materials forming a solid building wall or the like through the measurement of acoustic wave transmission therethrough. In the system and method for acoustic characterization of solid materials, the amplitude of the output acoustic wave is utilized, rather than the “quality” or absorption of energy within the wall as a function of the frequency of the acoustic energy transmitted through the wall.

Each solid has three characteristic frequencies associated therewith, referred to as “mat-formants”. A “formant” is a spectral peak of the acoustic spectrum of the human voice. A formant is typically measured as an amplitude peak in the frequency spectrum of the sound, using a spectrogram or a spectrum analyzer. In acoustics, the formant refers to a peak in the sound envelope and/or to a resonance in sound sources, notably musical instruments, as well as that of sound chambers. These formants are so accurate that recordation and comparison of voice imprints as a unique identifier is possible, with accuracy equivalent to that of an identifying signature. Thus, one can characterize a person from his or her acoustic imprint. Similarly, the mat-formant allows for the accurate characterization of a material in a solid sample.

In use, the method for acoustic characterization of solid materials, includes the following steps: (a) forming a database of known intensity spectra associated with a plurality of solid materials, at least one intensity peak as a function of acoustic frequency being associated with each intensity spectrum; (b) positioning an acoustic generator against a first surface of a sample to be tested; (c) positioning an acoustic sensor against a second surface of the sample to be tested, the first and second surfaces being longitudinally opposed with respect to one another; (d) generating an acoustic signal having a fixed intensity I₀ with the acoustic generator; (e) measuring an intensity spectrum of an attenuated acoustic signal transmitted through the sample with the acoustic sensor; and (f) comparing at least one intensity peak of the measured intensity spectrum of the attenuated acoustic signal against the database of known intensity spectra to determine at least one material forming the sample.

These and other features of the present invention will become readily apparent upon further review of the following specification and drawings.

### BRIEF DESCRIPTION OF THE DRAWINGS

FIG. 1 is a schematic diagram illustrating a system for acoustic characterization of solid materials according to the present invention.

FIG. 2 is a schematic diagram illustrating acoustic transmission and attenuation through a solid slab or wall.

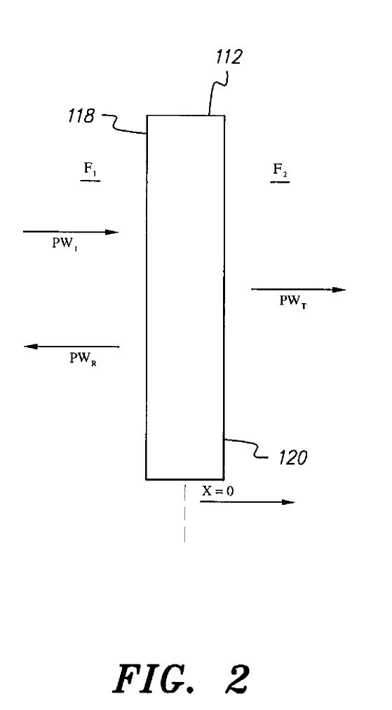

FIG. 3 is a graph illustrating acoustic energy attenuation as a function of acoustic frequency from the transmission illustrated in FIG. 2.

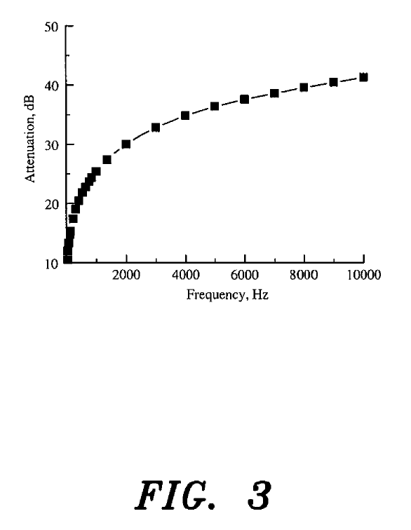

FIG. 4 is a graph illustrating acoustic output intensity as a function of frequency in a copper sample, comparing experimental data with intensity calculated via the method for acoustic characterization of solid materials according to the present invention.

FIG. 5 is a graph illustrating acoustic output intensity as a function of frequency in an aluminum sample, comparing experimental data with intensity calculated via the method for acoustic characterization of solid materials according to the present invention.

FIG. 6 is a graph illustrating acoustic output intensity as a function of frequency in a soda-lime glass sample, comparing experimental data with intensity calculated via the method for acoustic characterization of solid materials according to the present invention.

Similar reference characters denote corresponding features consistently throughout the attached drawings.

### DETAILED DESCRIPTION OF THE PREFERRED EMBODIMENTS

The system and method for acoustic characterization of solid materials provides for the characterization of the materials forming a solid building wall or the like through the measurement of acoustic wave transmission therethrough. In the system and method for acoustic characterization of solid materials, the amplitude of the output acoustic wave as a function of the frequency of the acoustic energy transmitted through the wall is utilized, rather than the “quality” or absorption of energy within the wall.

Each solid has three characteristic frequencies associated therewith, referred to as “mat-formants”. A “formant” is a spectral peak of the acoustic spectrum of the human voice. A formant is typically measured as an amplitude peak in the frequency spectrum of the sound using a spectrogram or a spectrum analyzer. In acoustics, the formant refers to a peak in the sound envelope and/or to a resonance in sound sources, notably musical instruments, as well as that of sound chambers. These formants are so accurate that recordation and comparison of voice imprints as a unique identifier is possible with an accuracy equivalent to that of an identifying signature. Thus, one can characterize a person from his or her acoustic imprint. Similarly, the mat-formant allows for the accurate characterization of a material in a solid sample.

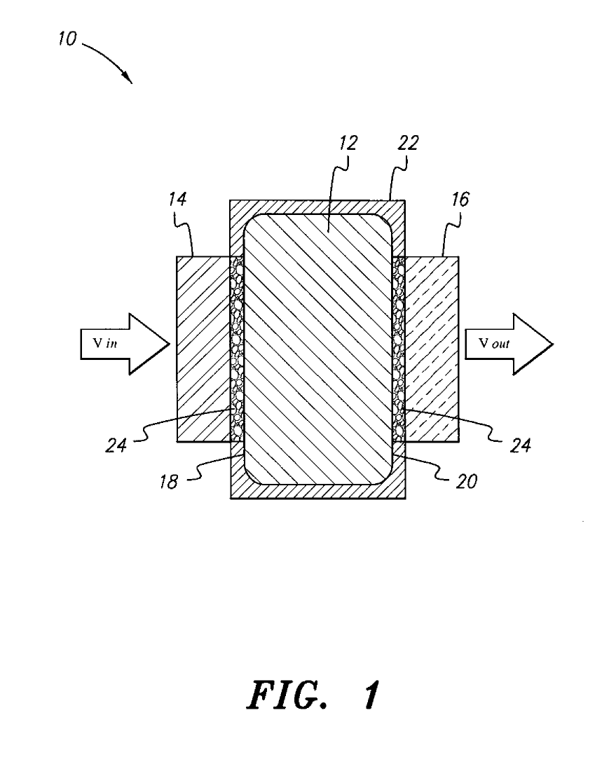

FIG. 1 diagrammatically illustrates the system for acoustic characterization of solid materials 10. In FIG. 1, a sample 12 to be analyzed is sandwiched between a speaker 14 and a microphone 16. Speaker 14 is positioned adjacent and contiguous to a first surface 18 of the sample 12, and the microphone 16 is positioned adjacent and contiguous to a second surface 20 of sample 12, preferably with no air gaps being formed between the speaker and microphone and their respective surfaces. It should be understood that any suitable type of acoustic sensor, acoustic transducer or the like may replace microphone 16, and that any suitable type of acoustic generator may be used in place of the speaker 14.

Preferably, in order to ensure that no air gaps are formed between the speaker, the microphone and their respective surfaces, an AC electrical source operating in the frequency range between 100 Hz and 12 kHz drives the speaker 14 to produce acoustic energy. The sample 12 is mounted in a sample holder 22 and sandwiched between the speaker 14 and the microphone 16 (which preferably are formed conventionally, having a diameter of approximately 2.54 cm and an input resistance of approximately 17Ω). A layer of castor oil 24 is formed on the opposing surfaces 18, 20 as an acoustic matching material at the interface between the microphone 16, the speaker 14, and the respective surfaces 18, 20. This inhibits the presence of undesired air and prevents reflections at the interfaces. It should be understood that any suitable type of oil may be utilized.

An input voltage νᵢₙ causes the speaker 14 to generate an acoustic wave, and the microphone 16 generates an output voltage νₒᵤₜ corresponding to the transmitted acoustic energy. The acoustic pressure within the sample 12 remains substantially constant, and measurements are preferably taken at room temperature. Any type of sample to be analyzed may be used, such as copper, aluminum or glass, without waveguide damping (i.e., the attenuation of sound is due solely to the sample 12).

In use, the first surface 18 of the sample 12 is stimulated with an acoustic intensity signal generated by the speaker 14. Although any desired intensity may be utilized, in the below example, the speaker 14 generates a sound wave with an initial intensity I₀ of approximately 5.5 nW/m², which is transmitted through the sample 12 and is detected by the microphone 16. The output voltage νₒᵤₜ (which is proportional to the output acoustic intensity) is then measured by any suitable type of voltmeter or the like. As noted above, there is no air gap between the sample 12 and the respective microphone 16 and speaker 14.

In the below analysis, the interface impedance between the sample 12 and the speaker 14 and the microphone 16 is neglected. If an electrical signal νᵢₙ is delivered to the speaker 14, the generated acoustic energy, which is a function of angular frequency ω, will pass through the sample 12, and the output result is a sound that reproduces as νₒᵤₜ, where νₒᵤₜ(ω) is the voltage measured between the output terminals of the microphone 16.

A simple simulation of the sample 12 can be made from a capacitor having capacitance C, connected in parallel with a resistor having resistance R. The product RC is, electronically, the time necessary to charge and discharge the capacitor through the resistor R. It will be shown below that the product RC is proportional to the relaxation time of the oscillators inside a solid matrix (i.e., atoms or molecules inside the solid matrix).

Taking into account that the sound pressure on the sample 12 inside the sample 12 and at both ends is constant, energy is conserved through the sample 12. Thus, according to Kirchhoff's law, the input voltage νᵢₙ(ω) and the output voltage νₒᵤₜ(ω) are related by the differential equation:

$${v}_{in} ( ω ) = RC \frac{d {v}_{out}}{d t} + {v}_{out} ( ω ) . \qquad ( 6 )$$

Equation (6) reduces to the following algebraic equation relating the input and output waveforms:

$${v}_{in} = ( iω RC + 1 ) {v}_{out} \to \frac{{v}_{out}}{{v}_{in}} = \frac{1}{1 + iω RC} , \qquad ( 7 )$$

where i=\sqrt{−1}. Electronically, the RC circuit represents a simple low pass filter; i.e., using similarity, the sample 12 is considered, physically, as an acoustical low frequency filter. The transfer function for the filter is a complex function where the real and the imaginary parts are given as:

$$\begin{matrix}Re \vert \frac{{v}_{out} ( ω , t )}{{v}_{in} ( ω , t )} \vert = \frac{1}{1 + {ω}^{2} {τ}^{2}} ; and & ( 8 a ) \\ Im \vert \frac{{v}_{out} ( ω , t )}{{v}_{in} ( ω , t )} \vert = \frac{ωτ}{1 + {ω}^{2} {τ}^{2}} . & ( 8 b )\end{matrix}$$

The amplitude of these last equations varies within −ω_{c} and +ω_{c}, where the amplitude attains its maximum at +ω_{c} for the acoustic dispersion (i.e., the imaginary part). For the real part, the amplitude suffers an inflection point at +ω_{c} (i.e., the acoustic impedance). At this critical frequency, the transfer of electric energy (i.e., electric conduction) is considered to be maximum, i.e., this maximum corresponds to the minimum time that is necessary to transfer acoustic energy (or electric current in the RC circuit) between the sample terminals.

Thus, the similarity between electric energy that passes through the RC circuit and acoustic energy that transfers across the solid substance allows for the consideration that the acoustic energy forces the atoms (or molecules) to relax within the internal matrix of the sample 12 with a relaxation time τ. The synchronization between the applied pressure frequency and τ attains a maximum at

$${ω}_{c} = \frac{1}{2 π} {f}_{c} = \frac{1}{τ} .$$

In the following, we consider that the sample 12 is composed of three low pass filters connected in mixed parallel and series connections. If the sample contains only one type of oscillator (i.e., an ultra-pure solid), a sound spectrum with only three maxima is expected, with each maximum corresponding to the relaxation time τ. However, if the solid contains different types of oscillators (for example, an alloy of different metals or a metal with uncontrolled impurities or chemical compounds), each oscillator provides its three peaks simultaneously, which leads to complex interference between the different components. This leads to numerous peaks in the sound spectrum, as is generally found in the acoustic spectrum.

The fast Fourier transformation (FFT), however, can analyze this spectrum to its fundamentals components. The term iωRC, obtained from the FFT, represents the atoms' (or molecules') relaxation with a relaxation time τ=RC given by equations (8a) and (8b). From a physical point of view, τ represents the relaxation time by which the acoustic energy affects the molecules inside the solid matter. Thus, for a pure solid, the total selective conduction is given by summing equation (8b) over the three possible relaxation times τ₁, τ₂ and τ₃. This can be written as:

$$Im \vert \frac{{v}_{out} ( ω , t )}{{v}_{in} ( ω , t )} \vert = {\sum }_{n = 1}^{3} \frac{ω {τ}_{n}}{1 + {ω}^{2} {τ}_{n}^{2}} \qquad ( 9 )$$

where equation (9) is derived by simulation of the sample with an RC circuit.

In the following, equation (9) will be derived assuming physical concepts, i.e., as the acoustic energy (or oscillating pressure) with an initial intensity of I₀ is applied, the atoms in the sample (copper atoms in the below example) within the lattice matrix will transfer this energy to the adjacent atoms in an oscillatory motion having a relaxation time τ. Thus, conservation of energy within the sample (at constant pressure) relates the instantaneous intensity I, the rate of energy transfer

$$\frac{d I ( t )}{d t} ,$$

### I₀ and τ as:

$${I}_{0} = I ( t ) + \frac{d I ( t )}{d t} τ . \qquad ( 10 )$$

This yields I₀−I(t)=iωτI(t). Thus, the following is true:

$${I}^{*} ( t ) = \frac{{I}_{0}}{1 + {ω}^{2} {τ}^{2}} - iωτ \frac{{I}_{0}}{1 + {ω}^{2} {τ}^{2}} , \qquad ( 11 )$$

where I* represents the complex portion. The real part (i.e., the first term) concerns the acoustic attenuation (i.e., the acoustic impedance) through the solid substance, and the second term represents the acoustic dispersion (acoustic conduction) through the solid. The two terms are phased with an angle of 90°. Thus, for a pure solid, the total selective conduction could be given by applying equations (10) and (11) over all of the three possible relaxation times τ₁, τ₂ and τ₃. This provides:

$$\begin{matrix}Re \vert {I}^{*} ( t ) \vert = {\sum }_{k = 1}^{k = 3} \frac{1}{1 + {ω}^{2} {τ}_{k}^{2}} {I}_{0} , \\ where & ( 12 ) \\ Im \vert {I}^{*} ( t ) \vert = {\sum }_{k = 1}^{k = 3} \frac{{ωτ}_{k}}{1 + {ω}^{2} {τ}_{k}^{2}} {I}_{0} . & ( 13 )\end{matrix}$$

The real part leads to the acoustic impedance, while the imaginary term stands for the acoustic dispersion (i.e., conduction). When plotting

$${\sum }_{k = 1}^{k = 3} \frac{{ωτ}_{k} {I}_{0}}{1 + {ω}^{2} {τ}_{k}^{2}}$$

as a function of the frequency, the result is the acoustic spectrum of the pure solid.

In use, the method for acoustic characterization of solid materials, includes the following steps: (a) forming a database of known intensity spectra associated with a plurality of solid materials, at least one intensity peak as a function of acoustic frequency being associated with each intensity spectrum; (b) positioning an acoustic generator against a first surface of a sample to be tested; (c) positioning an acoustic sensor against a second surface of the sample to be tested, the first and second surfaces being longitudinally opposed with respect to one another; (d) generating an acoustic signal having a fixed intensity I₀ with the acoustic generator; (e) measuring an intensity spectrum of an attenuated acoustic signal transmitted through the sample with the acoustic sensor; and (f) comparing at least one intensity peak of the measured intensity spectrum of the attenuated acoustic signal against the database of known intensity spectra to determine at least one material forming the sample.

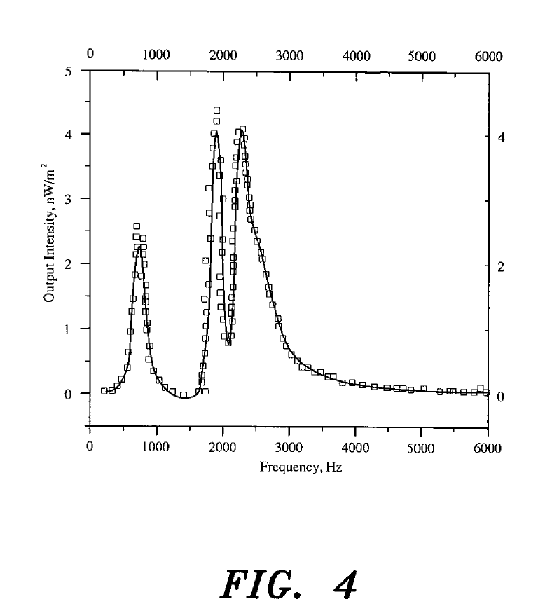

FIG. 4 illustrates the output acoustic intensity in nW/m² as a function of the frequency for a copper sample. In FIG. 4, the mat-formants are strongly shown as three distinct peaks at the fundamentals f₁=1815 Hz (which corresponds to output power I₁=3.4 nW/m²), f₂=1947 Hz (I₂=4.46 nW/m²) and f₃=2052 Hz (I₃=4.13 nW/m²). The output power I_{acoustic} lies in the range of the audible intensity: 0<I_{acoustic}<5.5 nW/m².

When fitting the experimental results of FIG. 4 with Equation (13), the best fit of the experimental values are found when τ₁=8.7×10−5 seconds, τ₂=8.0×10−5 seconds and τ₃=7.7×10−5 seconds. These times correspond to

$${τ}_{1} = \frac{1}{2 π} {f}_{1} , {τ}_{2} = \frac{1}{2 π} {f}_{2} , and {τ}_{3} = \frac{1}{2 π} {f}_{3} ,$$

along with I₀=5.5×10⁻⁹ W/m². In FIG. 4, the solid line represents the calculated values and the blocks represent the experimental values.

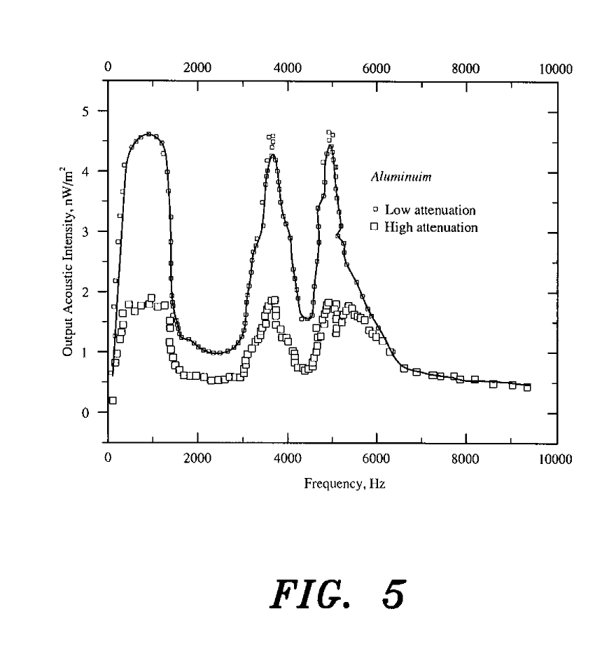

FIG. 5 illustrates the output acoustic intensity in nW/m² as a function of the frequency for an aluminum sample. In FIG. 5, the mat-formants are strongly shown as three distinct peaks at the fundamentals f₁=946 Hz (which corresponds to output power I₁=4.66 nW/m²), f₂=3644 Hz (I₂=4.6 nW/m²) and f₃=4923 Hz (I₃=4.55 nW/m²). FIG. 5 also shows another acoustic spectrum for aluminum, where the sample is thicker than the first, thus the attenuation of the output intensity I is highly manifested in the thicker sample.

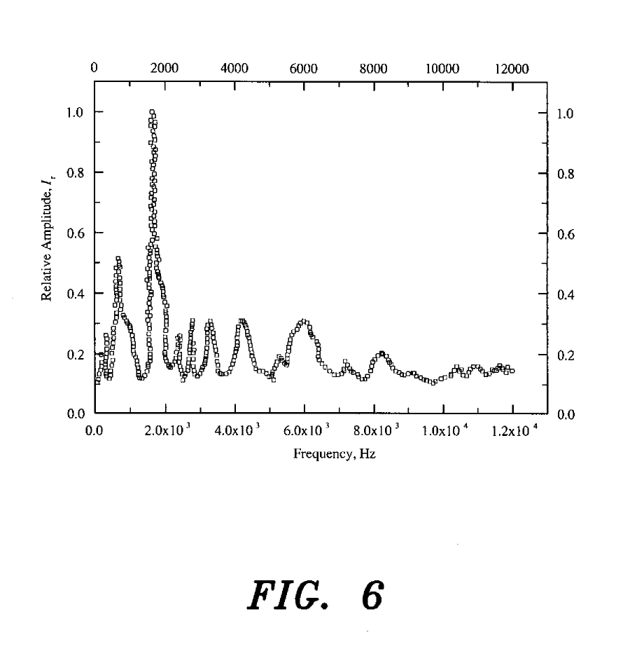

FIG. 6 shows the sound spectrum of a soda-lime glass sample that is 2 mm thick. The plot in FIG. 6 is shown as several continuous peaks of the output relative intensity

$${I}_{R} = \frac{I}{{I}_{0}} = \frac{{v}_{out}}{{v}_{in}}$$

as a function of frequency, f=ω/2π. Within the audio frequency range, which varies in the range of 100 Hz<f<12 kHz, there are 27 peaks of I_{R}, and within these peaks there are three maxima: at f₁=2000 Hz with relative intensity of 1, f₂=2180 Hz with relative intensity of 0.8, and f₃=800 Hz, with relative intensity of 0.65.

As described above, the glass sample (along with all solid substances that contain more than one oscillator) has been modeled as though composed of three low pass filters connected in a mixed fashion (i.e., one filter is in series with the other two filters, which are connected in parallel). Using the FFT to fit the experimental data to the present model, it is possible to take all three periodic functions (in time) f₁(t), f₂(t) and f₃(t), and resolve them into equivalent infinite summations of sine and cosine waves with frequencies that start from 0 and increase in integer multiples of a base frequency f₀ₘ=1/T, where T is the period of fₘ(t) for each filter.

The resulting infinite series is written as:

$${f}_{m} ( t ) = \frac{{a}_{0}}{2} + {\sum }_{1}^{∞} [ {a}_{n} cos ( n ω t ) + {b}_{n} sin ( n ω t ) ] \qquad ( 14 )$$

where m is the number of low pass filters: m=1, 2 or 3. The purpose of a FFT is to figure out all the values of the parameters aₙ and bₙ to produce a Fourier series, given the three base frequencies and the functions fₘ(t).

Fitting of the experimental data is accomplished in three independent repetitive cycles, starting with m=1, which corresponds to the first natural frequency of the glass. This first frequency is the fundamental bypass frequency f₀₁=2000 kHz. Next, suitable values of aₙ and bₙ are found which fit the first maximum, which lies at f₀₁. Next, the cycle is repeated for f₀₂=2180 Hz, and finally for f₀₃=800 Hz. In this example, a sampling rate of 10 readings/second has been used, which is suitable for providing sufficient readings to assess the peak.

For the first filter (with frequency f₀₁), we find the number of peaks N, within the whole sound spectrum, that are in harmony with the natural frequency f₀₁. If one processes these six records with the FFT, the output is the sine and cosine coefficients aₙ and bₙ for the frequencies 2,000 Hz, 2×2,000 Hz=6,000 Hz, 3×2,000 Hz=18,000 Hz, etc. If the FFT is used to process a series of numbers for a glass sample into a sound, the results would be

$${a}_{01} = 1 , {a}_{n} = \frac{{( - 1 )}^{n}}{n} and {b}_{n} = \frac{1}{2 n - 1} .$$

For the frequencies 2,000 Hz, 6,000 Hz and 18,000 Hz, the relation

$$T = \frac{2 π}{b}$$

is used, thus resulting in

$$12 , 000 \times \frac{2 π}{6} = 1.2566 \times {10}^{4} .$$

Thus, the Fourier series for the first filter with m=1 provides equation (15) below:

$${f}_{01} ( t ) = \frac{1}{2} + {\sum }_{1}^{6} [ \frac{{( - 1 )}^{n}}{n} cos ( 1.2566 \times {10}^{4} ) nt + \frac{1}{( 2 n - 1 )} sin ( 1.2566 \times {10}^{4} nt ) ] .$$

Repeating this procedure for the other two filters with a₀₁=0.8 for f₀₂ and a₀₃=0.65 for f₀₃ yields the two functions f₀₂ and f₀₃.

Next, in order to construct the total sound spectrum, f₀₀(t) of the glass at room temperature, the connection between f₀₁, f₀₂ and f₀₃ is considered. The best fit occurs when one considers the mixed connection as:

$${f}_{00} ( t ) = {f}_{01} ( t ) + \frac{{f}_{02} ( t ) {f}_{03} ( t )}{{f}_{02} ( t ) + {f}_{03} ( t )} , \qquad ( 15 )$$

where the second and third filters are connected in parallel, and connected with the first filter in series. The results are shown in FIG. 6.

The sound spectrum of several other solids have been determined and the respective analyses are summarized below in Table 1:

TABLE 1

| | Natural frequencies | Attenuation, I (nW/m²)/I₀ |
|---|---|---|
| Solid | (mat-formants) (Hz) | (5.5 nW/m²) |
| Copper | f₁ = 1815, f₂ = 1947 | I₁ = 3.4, I₂ = 4.4 and |
| | f₃ = 2052 | I₃ = 4.1 |
| Aluminum | f₁ = 946, f₂ = 3644 | I₁ = 4.6, I₂ = 4.6 and |
| | and f₃ = 4923 | I₃ = 4.5 |
| Iron | f₁ = 223, f₂ = 398 and | I₁ = 4.8, I₂ = 4.6 and |
| | f₃ = 1009 | I₃ = 3.7 |
| Lead | f₁ = 984 f₂ = 3033 | I₁ = 5.5, I₂ = 4.5 and |
| | and f₃ = 6513 | I₃ = 4.2 |
| Glass | f₁ = 800, f₂ = 2000 | I₁ = 3.5, I₂ = 5.5 and |
| | and f₃ = 2180 | I₃ = 5.0 |
| Mica | f₁ = 529, f₂ = 2189 | I₁ = 5.5, I₂ = 4.2 and |
| | and f₃ = 3063 | I₃ = 2.7 |
| Acrylic | f₁ = 505, f₂ = 1884 | I₁ = 2.27, I₂ = 5.5 and |
| | and f₃ = 2576 | I₃ = 4.6 |

It is to be understood that the present invention is not limited to the embodiment described above, but encompasses any and all embodiments within the scope of the following claims.

We claim:

1. A method for acoustic characterization of solid materials, comprising the steps of:
forming a database of known intensity spectra associated with a plurality of solid materials;
positioning an acoustic generator against a first surface of a sample to be tested;
positioning an acoustic sensor against a second surface of the sample to be tested, the first and second surfaces being longitudinally opposed with respect to one another;
generating an acoustic signal having a fixed intensity I₀ with the acoustic generator;
measuring an intensity spectrum of an attenuated acoustic signal transmitted through the sample with the acoustic sensor; and
comparing the measured intensity spectrum of the attenuated acoustic signal against the database of known intensity spectra to determine at least one material forming the sample.

2. The method for acoustic characterization of solid material as recited in claim 1, further comprising the step of forming a layer of acoustically conductive fluid between the acoustic generator and the first surface to prevent the formation of an air gap therebetween.

3. The method for acoustic characterization of solid material as recited in claim 2, further comprising the step of forming a layer of acoustically conductive fluid between the acoustic sensor and the second surface to prevent the formation of an air gap therebetween.

4. The method for acoustic characterization of solid material as recited in claim 1, wherein the step of forming a database of known intensity spectra associated with the plurality of solid materials includes experimentally determining at least one intensity peak as a function of acoustic frequency for each intensity spectrum.

5. The method for acoustic characterization of solid material as recited in claim 4, wherein the step of comparing the measured intensity spectrum of the attenuated acoustic signal against the database of known intensity spectra to determine the at least one material forming the sample includes the step of comparing at least one measured intensity peak at a specific frequency associated therewith in the measured intensity spectrum against the at least one intensity peak associated with each of the known intensity spectra.

6. The method for acoustic characterization of solid material as recited in claim 5, wherein the step of comparing the measured intensity spectrum of the attenuated acoustic signal against the database of known intensity spectra to determine the at least one material forming the sample includes the step of comparing first, second and third measured intensity peaks at first, second and third frequencies in the measured intensity spectrum against first, second and third intensity peaks associated with each of the known intensity spectra.

7. A method for acoustic characterization of solid materials, comprising the steps of:
forming a database of known intensity spectra associated with a plurality of solid materials, at least one intensity peak as a function of acoustic frequency being associated with each intensity spectrum;
positioning an acoustic generator against a first surface of a sample to be tested;
positioning an acoustic sensor against a second surface of the sample to be tested, the first and second surfaces being longitudinally opposed with respect to one another;
generating an acoustic signal having a fixed intensity I₀ with the acoustic generator;
measuring an intensity spectrum of an attenuated acoustic signal transmitted through the sample with the acoustic sensor; and
comparing at least one intensity peak of the measured intensity spectrum of the attenuated acoustic signal against the database of known intensity spectra to determine at least one material forming the sample.

8. The method for acoustic characterization of solid material as recited in claim 7, further comprising the step of forming a layer of acoustically conductive fluid between the acoustic generator and the first surface to prevent the formation of an air gap therebetween.

9. The method for acoustic characterization of solid material as recited in claim 8, further comprising the step of forming a layer of acoustically conductive fluid between the acoustic sensor and the second surface to prevent the formation of an air gap therebetween.

10. The method for acoustic characterization of solid material as recited in claim 9, wherein the step of comparing the at least one intensity peak of the measured intensity spectrum of the attenuated acoustic signal against the database of known intensity spectra to determine at least one material forming the sample includes the step of comparing first, second and third measured intensity peaks at first, second and third frequencies in the measured intensity spectrum against first, second and third intensity peaks associated with each of the known intensity spectra.

11. A system for acoustic characterization of solid materials, comprising:
an acoustic generator adapted for positioning against a first surface of a sample to be tested, the acoustic generator selectively generating an acoustic signal having a fixed intensity I₀;
an acoustic sensor adapted for positioning against a second surface of the sample to be tested, the first and second surfaces being longitudinally a opposed with respect to one another;
means for measuring an intensity spectrum of an attenuated acoustic signal transmitted through the sample with the acoustic sensor; and
means for comparing at least one intensity peak of the measured intensity spectrum of the attenuated acoustic signal against a database of known intensity spectra associated with a plurality of solid materials, at least one intensity peak as a function of acoustic frequency being associated with each intensity spectrum, to determine at least one material forming the sample.

12. The system for acoustic characterization of solid materials as recited in claim 11, further comprising a first layer of acoustically conductive fluid formed between the acoustic generator and the first surface to prevent the formation of an air gap therebetween.

13. The system for acoustic characterization of solid materials as recited in claim 12, further comprising a second layer of acoustically conductive fluid formed between the acoustic generator and the first surface to prevent the formation of an air gap therebetween.

14. The system for acoustic characterization of solid materials as recited in claim 13, wherein the first and second layers of acoustically conductive fluid are each formed from castor oil.
